(19) United States
(12) Patent Application Publication
(10) Pub. No.: US 2026/0303949 A1
(43) Pub. Date: Oct. 1, 2026

(54) ELECTRONIC DEVICE

(71) Applicant: CANON KABUSHIKI KAISHA, Tokyo (JP)

(72) Inventor: TAKUMI KAWASHIMA, Tokyo (JP)

(21) Appl. No.: 19/535,484

(22) Filed: Feb. 10, 2026

(30) Foreign Application Priority Data
Mar. 26, 2025 (JP) 2025-051269

(51) Int. Cl. H04N 23/63; H04N 23/62

(52) U.S. Cl. CPC H04N 23/631; H04N 23/62; H04N 23/635

(57) ABSTRACT

An electronic device according to the present disclosure executes an acquisition process of acquiring an image, executes a switching process of switching display of information between ON and OFF in response to a first user operation, executes a setting process of setting one or more elements configuring the information to ON or OFF according to a second user operation different from the first user operation, and executes a control process to, in a case where the display of the information is switched from OFF to ON by the switching process, if there is an element set to ON by the setting process, perform control to display the information including the element in a superimposed manner on the image, and if there is no element set to ON by the setting process, perform control to display a screen related to the setting by the setting process.

### BACKGROUND

### Field of the Technology

The present disclosure relates to an electronic device, and more particularly, to a technology for performing setting related to information to be displayed on an image in a superimposed manner.

### DESCRIPTION OF THE RELATED ART

As an application for a smartphone, a camera control application for controlling a camera connected to the smartphone has been proposed. The camera control application may have a function of displaying a live view (LV) image of the camera, a function of displaying a marker for composition confirmation to be superimposed on the LV image, and the like. Since there are various markers such as a center marker and an aspect marker, the camera control application generally has a function of setting (selecting) a display target marker as well as a function of switching the display of the marker between enabled and disabled.

The frequency of switching the display of the marker between enabled and disabled is higher than the frequency of setting (changing) the display target marker. Therefore, in the camera control application, an item for a user operation to switch the display of the marker between enabled and disabled is often displayed in a hierarchy higher than an item for a user operation to set the display target marker. For example, an item for a user operation to switch the display of the marker between enabled and disabled is displayed on a screen displaying the LV image. Then, an item for a user operation to set the display target marker is displayed on another setting screen called from the screen displaying the LV image.

Japanese Patent Laid-Open No. 2020-004257 discloses a technique of displaying a menu screen in a state where a specific menu item to be selected is emphasized according to a specific operation.

As described above, a marker may be displayed for composition confirmation. However, even when the display of the marker is switched from OFF to ON, the marker

is not displayed unless the display target marker is set (selected). In this case, the user cannot easily grasp the reason why the marker is not displayed. Even if the technology disclosed in Japanese Patent Laid-Open No. 2020-004257 is used, this problem cannot be solved. The same problem may occur not only in the case of displaying the selected marker but also in the case of displaying other types of information including the selected element.

### SUMMARY

The present disclosure provides a technology that enables a user to easily grasp a reason why information is not displayed in the case of displaying information including selected elements.

An electronic device according to the present disclosure includes a processor, and a memory storing a program which, when executed by the processor, causes the electronic device to execute an acquisition process of acquiring an image, execute a switching process of switching display of information between ON and OFF in response to a first user operation, execute a setting process of setting one or more elements configuring the information to ON or OFF according to a second user operation different from the first user operation, and execute a control process to, in a case where the display of the information is switched from OFF to ON by the switching process, if there is an element set to ON by the setting process, perform control to display the information including the element in a superimposed manner on the image, and if there is no element set to ON by the setting process, perform control to display a screen related to the setting by the setting process.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating a configuration example of a system.

FIG. 2A is a block diagram illustrating a configuration example of a camera.

FIG. 2B is a block diagram illustrating a configuration example of a smartphone.

FIG. 3 is a schematic diagram illustrating a screen example of a camera control application.

FIGS. 4A to 4C are schematic diagrams illustrating screen examples of the camera control application.

FIGS. 5A and 5B are schematic diagrams illustrating screen examples of the camera control application.

FIG. 6 is a flowchart illustrating an operation of a smartphone.

FIGS. 7A and 7B are schematic diagrams illustrating screen examples of a camera control application.

FIG. 8 is a flowchart illustrating an operation of a smartphone.

### DESCRIPTION OF THE EMBODIMENTS

### First Embodiment

Hereinafter, a first embodiment of the present disclosure will be described.

### System Configuration

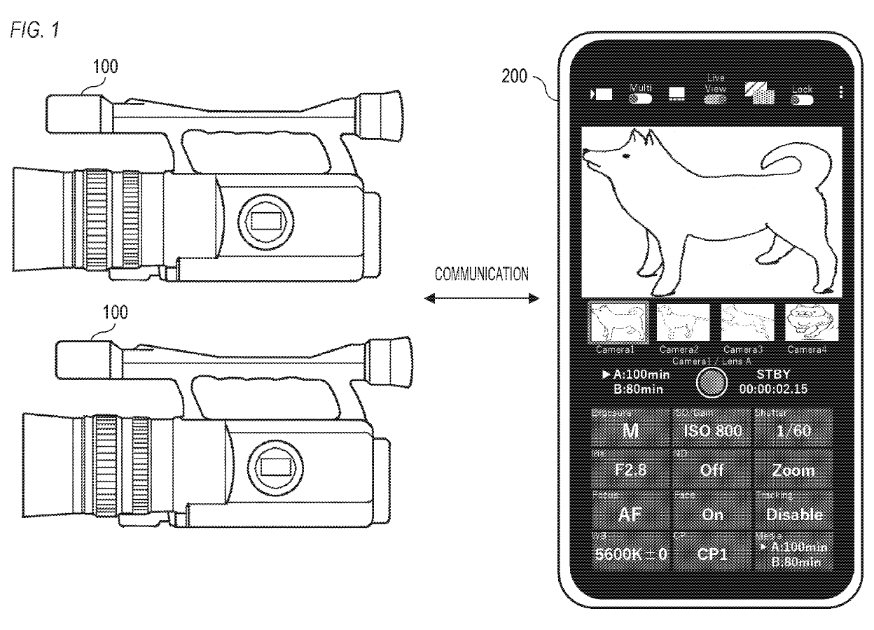

FIG. 1 is a schematic diagram illustrating a configuration example of a system according to the first embodiment. In the system of FIG. 1, a plurality of cameras 100 and a smartphone 200 are communicably connected to each other. FIG. 1 illustrates two cameras 100 but the number of the cameras 100 is not particularly limited. One camera 100 may be connected to the smartphone 200, or three or more cameras 100 may be connected to the smartphone 200. A communication system (standard) is also not particularly limited and may be, for example, Wi-Fi (registered trademark), Bluetooth (registered trademark), or a wireless communication system exclusive to a manufacturer. The communication between the cameras 100 and the smartphone 200 may be wireless communication or wired communication. A communication system in the wired communication is also not particularly limited and may be, for example, RS-232C, RS-422A, USB, or Ethernet (registered trademark). Any communication system capable of transmitting and receiving a video and transmitting and receiving a setting value of a camera is applicable.

### Configuration of Camera

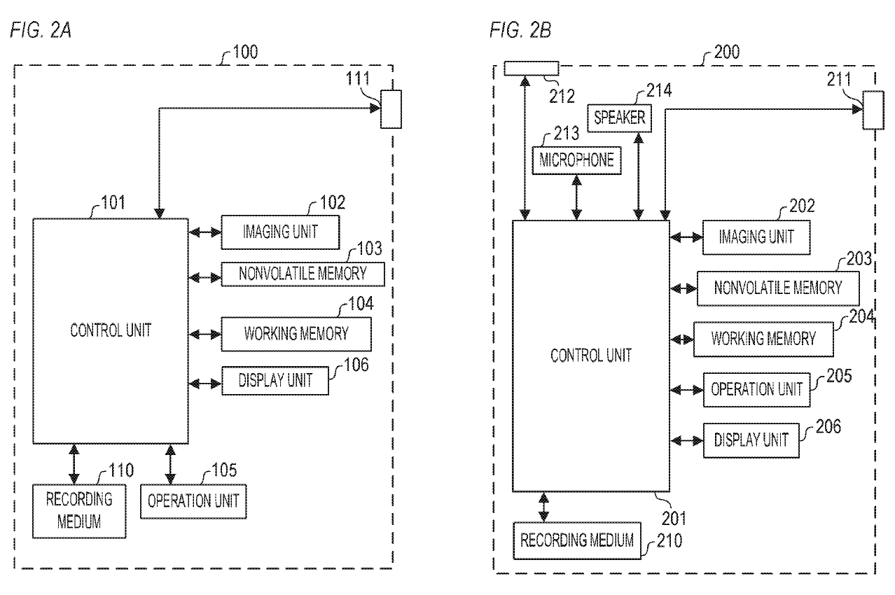

FIG. 2A is a block diagram illustrating a configuration example of the camera 100 (video camera) as an example of a data processing device according to the first embodiment. The data processing device is not limited to the camera 100. For example, the data processing device may be an electronic device such as a tablet device or a personal computer.

A control unit 101 controls each unit in the camera 100 according to an input signal and a program described below. Instead of causing the control unit 101 to control the entire camera 100, the processing may be shared by a plurality of hardware to control the entire camera 100.

An imaging unit 102 converts object light focused by a lens in the imaging unit 102 into an electrical signal, executes noise reduction processing or the like, and outputs image data that is digital data. The captured image data is accumulated in a buffer memory, is subjected to predetermined processing by the control unit 101, and is recorded in a recording medium 110.

A nonvolatile memory 103 is a nonvolatile memory that is electrically erasable and recordable, and stores a program described below to be executed by the control unit 101 or the like.

A working memory 104 is used as a buffer memory that temporarily stores the image data captured by the imaging unit 102, an image display memory of a display unit 106, a work area of the control unit 101, or the like.

An operation unit 105 is used for receiving an instruction for the camera 100 from a user. The operation unit 105 includes, for example, operation members operated by the user, such as a power button for instructing ON/OFF of a power supply of the camera 100, a release switch for instructing shooting, and a replay button for instructing replay of image data. The operation unit 105 also includes a touch panel formed in the display unit 106. The release switch includes a switch SW1 and a switch SW2. The switch SW1 is turned ON when the release switch enters a so-called half-pressed state. As a result, an instruction for executing shooting preparations such as autofocus (AF) processing, autoexposure (AE) processing, auto white balance (AWB) processing, and pre-flash (EF) processing is received. The switch SW2 is turned ON when the release switch enters a so-called full-pressed state. As a result, an instruction for executing shooting is received.

The display unit 106 displays a live view image (LV image) as a captured image showing an object substantially in real time, a shot (recorded) captured image, text for interactive operation, and the like. The display unit 106 is not necessarily built in the camera 100. It is only necessary that the camera 100 can be connected to the internal or external display unit 106 and has a display control function of controlling display of the display unit 106.

The recording medium 110 can store image data output from the imaging unit 102. The recording medium 110 may be attachable and detachable with respect to the camera 100 or may be built in the camera 100. The camera 100 only needs to have a function of accessing at least the recording medium 110.

The connection unit 111 is an interface for connection to an external device. The camera 100 can exchange data with the external device via the connection unit 111. The connection unit 111 includes, for example, an interface for communication with the external device via a wireless LAN. The control unit 101 implements wireless communication with the external device by controlling the connection unit 111.

Note that, the camera 100 can operate as a slave device in an infrastructure mode of wireless LAN communication. During operation as a slave device, the camera 100 can be connected to a peripheral access point (hereinafter, AP) to participate in a network formed by the AP. The camera 100 is one type of AP and can also operate as a simplified AP (hereinafter, simple AP) having a limited function. An AP is an example of a relay device. When the camera 100 operates as a simple AP, the camera 100 itself forms a network. A peripheral device of the camera 100 can recognize the camera 100 as an AP and participate in the network formed by the camera 100. A program for allowing the camera 100 to operate as described above is stored in the nonvolatile memory 103. Although the camera 100 is one type of AP, it is a simple AP not having a gateway function of transferring data received from a slave device to an Internet service provider or the like. Accordingly, even when the camera 100 receives data from another device participating in the network formed by the camera 100 itself, the camera 100 cannot transfer the received data to a network such as the Internet. Alternatively, the connection unit 111 may be an interface of wired communication instead of wireless communication.

As described above, a communication system with the external device is not particularly limited. The connection unit 111 may be an interface for executing wired communication by a system such as RS-232C, RS-422A, USB, or Ethernet (registered trademark).

### Configuration of Smartphone

FIG. 2B is a block diagram illustrating a configuration example of the smartphone 200 as an example of a control device according to the first embodiment. The control device is not limited to the smartphone 200. For example, the control device may be an electronic device such as a digital camera, a mobile media player, a tablet device, a personal computer, or a mobile phone.

A control unit 201 controls each unit in the smartphone 200 according to an input signal or a program described below. Instead of causing the control unit 201 to control the entire smartphone 200, the processing may be shared by a plurality of pieces of hardware to control the entire smartphone 200.

An imaging unit 202 converts object light focused by a lens in the imaging unit 202 into an electrical signal, executes noise reduction processing or the like, and outputs digital data as image data. The captured image data is accumulated in a buffer memory, is subjected to predetermined processing by the control unit 201, and is recorded in a recording medium 210.

A nonvolatile memory 203 is a nonvolatile memory that is electrically erasable and recordable, and stores an operating system (OS) that is basic software to be executed by the control unit 201, various programs, and the like. A program for communication with the camera 100 is also stored in the nonvolatile memory 203, and is installed as a camera control application. The processing of the smartphone 200 is implemented by reading a program of the camera control application. The camera control application has a function for using basic functions (for example, a function of a wireless LAN, a function of Bluetooth, and a function of calling another application) of the OS installed in the smartphone 200. The camera control application has a remote shooting function of remotely operating and causing the camera 100 to shoot from the smartphone 200 while viewing the LV image obtained from the camera 100 by the smartphone 200. The camera control application has a remote viewing function of remotely viewing image data stored in a recording medium mounted on the camera 100 or receiving the image data. The OS of the smartphone 200 may have the functions of the first embodiment (for example, the function of the camera control application).

A working memory 204 is used as a buffer memory that temporarily stores the image data captured by the imaging unit 202, an image display memory of a display unit 206, a work area of the control unit 201, and the like.

An operation unit 205 is used for receiving an instruction for the smartphone 200 from the user. The operation unit 205 includes, for example, operation members operated by the user, such as a power button for instructing ON/OFF of a power supply of the smartphone 200 or a touch panel formed in the display unit 206.

The display unit 206 displays an image, text for interactive operation, or the like. The display unit 206 is not necessarily built in the smartphone 200. It is only necessary that the smartphone 200 can be connected to the internal or external display unit 206 and has a display control function of controlling display of the display unit 206.

The recording medium 210 can store image data output from the imaging unit 202, image data received from the camera 100, and the like. The recording medium 210 may be attachable and detachable with respect to the smartphone 200 or may be built in the smartphone 200. The smartphone 200 only needs to have a function of accessing at least the recording medium 210.

A connection unit 211 is an interface for connection to an external device. The smartphone 200 can exchange data with the external device via the connection unit 211. The connection unit 211 includes, for example, an interface for communication with the external device via a wireless LAN. The control unit 201 implements wireless communication with the external device by controlling the connection unit 211.

The smartphone 200 can operate as a slave device in an infrastructure mode of wireless LAN communication and can participate in a network formed by a peripheral AP. The camera 100 may operate as a simple AP so that the smartphone 200 participates in the network formed by the camera 100.

A public network connection unit 212 is an interface used to perform public wireless communication. The smartphone 200 is connected to another device via the public network connection unit 212 and can execute data communication with the other device or make a call with a user of the other device. During the call, the control unit 201 acquires a voice signal via a microphone 213 or outputs a voice signal via a speaker 214. The public network connection unit 212 includes, for example, an interface for executing communication using 3G, 4G, or 5G. The communication system is not particularly limited and may be, for example, LTE, WiMAX, ADSL, or FTTH. The connection unit 211 and the public network connection unit 212 do not need to be configured as independent hardware, and for example, one antenna may function as both the connection unit 211 and the public network connection unit 212.

In the following description, there are cases where the smartphone 200 is described as the subject of processing. However, in practice, the control unit 201 implements various types of processing by reading and executing the program stored in the nonvolatile memory 203. Likewise, the camera 100 may be described as the subject of processing, but in practice, the control unit 101 implements various types of processing by reading and executing the programs stored in the nonvolatile memory 103.

### Screen Example of Smartphone

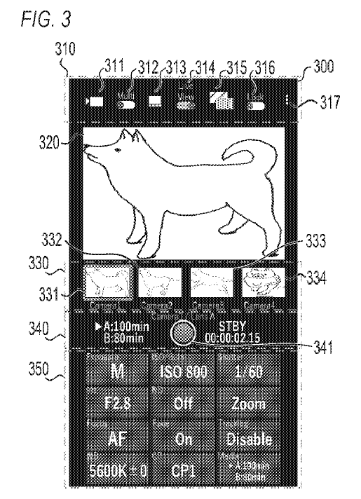

FIGS. 3 to 5B are schematic diagrams illustrating screen examples of the camera control application displayed on the display unit 206 by the smartphone 200. The camera control application is connected to a plurality of cameras simultaneously and enables operation of each of the cameras. The camera control application receives an LV image and various types of data of the camera via communication with the camera, and enables display of the LV image and the data on the display unit 206. The display unit 206 is a display unit capable of receiving a touch operation, such as a display unit on which a touch panel is formed.

FIG. 3 is a schematic diagram illustrating an example of a main screen of the camera control application. In FIG. 3, the control unit 201 is connected to the camera by the camera control application, receives an LV image and various current setting values of the camera from the camera, and displays the LV image and the setting values on a main screen 300. The control unit 201 is able to acquire an LV image and the like from one or more connected cameras.

The control unit 201 displays a header portion 310 for changing various settings in an upper portion of the main screen 300. For example, the control unit 201 displays a camera connection setting button 311, a multi-view selector switch 312, a view switching button 313, an LV display switch 314, an assistance setting button 315, and a screen lock switch 316, in the header portion 310. The control unit 201 also displays an additional setting button 317 in the header portion 310.

The camera connection setting button 311 is a setting button for connection or disconnection with the camera. The view switching button 313 is a setting button for selecting a display mode (view) of the LV image, such as a normal display mode, a multi-screen display mode, or a full-screen display mode (each of the display modes will be described below). The assistance setting button 315 is a setting button for selecting an assistance function such as enlarged display, marker display, or false-color display (various assistance functions will be described below). An additional setting button 317 is a setting button for additional settings. When the user touches any of the setting buttons, the control unit 201 transitions the display screen (displayed screen) to a setting screen corresponding to the touched setting button.

The multi-view selector switch 312 is a selector switch for performing switching to enable/disable the multi-view. The LV display switch 314 is a selector switch for performing switching to enable/disable the LV display. The screen lock switch 316 is a selector switch for performing switching to enable/disable the screen lock. When the user touches these selector switches, the control unit 201 performs switching to enable/disable the function corresponding to the touched selector switch. In FIG. 3, the multi-view selector switch 312 is in a disabled state, the LV display switch 314 is in an enabled state, and the screen lock switch 316 is in a disabled state. An enabled state of a switch is a state where the function corresponding to the switch is enabled, and a disabled state of a switch is a state where the function corresponding to the switch is disabled.

The control unit 201 also displays an LV area 320 and a sub-LV area 330 on the main screen 300. The control unit 201 displays an LV image (main image) acquired from the camera to be operated in the LV area 320, and displays all the LV images acquired from the connected cameras in the sub-LV area 330. In FIG. 3, four cameras (cameras 1 to 4) are connected to the control unit 201, and four LV images 331 to 334 acquired from the four cameras, respectively, are aligned and displayed in the sub-LV area 330. When the user touches any of the LV images 331 to 334, the control unit 201 selects the touched LV image as a main image, and selects the camera corresponding to the touched LV image as the operation target. In FIG. 3, the LV image 331 (camera 1) is selected. The control unit 201 displays a cursor surrounding the LV image 331 as a cursor indicating that the LV image 331 is selected. The control unit 201 displays an LV image that is the same as the LV image 331, in the LV area 320. When the number of connected cameras is one, the camera is selected as the operation target.

The control unit 201 also displays a recording information area 340 and an operation area 350 on the main screen 300. The control unit 201 displays a recording state of an image in the camera to be operated or displays a recording start/stop button 341 for instructing start or stop of recording, in the recording information area 340. For example, as the recording state, a medium remaining time, a time code, a REC

(recording)/STBY (standby) state, and the like are displayed. When the user touches the recording start/stop button 341 at the center, the control unit 201 instructs the camera to be operated to start or stop recording of the video. The control unit 201 displays an operation button group in the operation area 350. A current setting value to be changed by an operation button is displayed on the operation button. When the user touches the operation button, the control unit 201 instructs the camera to be operated to change the setting value corresponding to the touched operation button, or shifts the display screen to the setting screen for changing the setting value corresponding to the touched operation button. When the user touches the operation area 350 and executes a sliding operation to move the touch position (touch-move), the control unit 201 scrolls the operation button group and displays the operation buttons that were not displayed in the operation area 350.

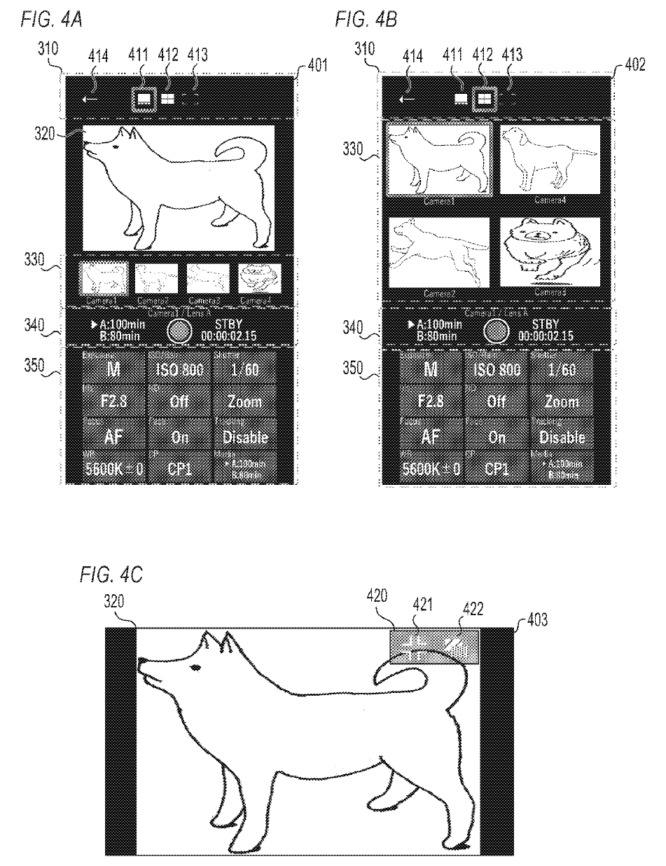

FIGS. 4A and 4B are schematic diagrams illustrating screen examples of the camera control application, and illustrate an example of switching of the LV display mode.

FIG. 4A illustrates an example of a screen in the normal display mode. A screen 401 of FIG. 4A is the same as the main screen 300 of FIG. 3, but FIGS. 4A and 3 are different in the display state (display content) of the header portion 310. For example, when the user touches the view switching button 313 while the main screen 300 of FIG. 3 is being displayed, the control unit 201 switches the display state of the header portion 310 from the state of FIG. 3 to the state of FIG. 4A. In FIG. 4A, a normal display button 411, a 2×2 display button 412, a full-screen display button 413, and a return button 414 are displayed in the header portion 310. When the user touches the normal display button 411, the 2×2 display button 412, or the full-screen display button 413, the control unit 201 switches the display mode to the mode corresponding to the touched button. In FIG. 4A, a cursor surrounding the normal display button 411 is displayed, thereby showing that the display mode is the normal display mode. When the user touches the return button 414, the control unit 201 switches the display state of the header portion 310 from the state of FIG. 4A to the state of FIG. 3.

FIG. 4B illustrates an example of a screen in the 2×2 display mode. For example, when the user touches the 2×2 display button 412 while the screen 401 of FIG. 4A is being displayed, the control unit 201 transitions the display screen from the screen 401 of FIG. 4A to a screen 402 of FIG. 4B. The 2×2 display mode is a multi-screen display mode where the LV area 320 is not displayed and the sub-LV area 330 is displayed, and is a display mode where four LV images are displayed in two rows and two columns. In the 2×2 display mode, as in the normal display mode (while the screen 300 or 401 of FIGS. 3 or 4A is being displayed), the camera to be operated is selected according to a touch on the LV image in the sub-LV area 330. In FIG. 4B, a cursor surrounding the LV image (main image) of the camera to be operated, among the four LV images in two rows and two columns, is displayed. As in the screens 300 and 401 of FIGS. 3 and 4A, the recording information area 340 and the operation area 350 are displayed on the screen 402 of FIG. 4B.

FIG. 4C illustrates an example of a screen in the full-screen display mode. For example, when the user touches the full-screen display button 413 while the main screen 401 of FIG. 4A is being displayed, the control unit 201 transitions the display screen from the screen 401 of FIG. 4A to a screen 403 of FIG. 4C. The full-screen display mode is a display mode where the LV area 320 (main image) is displayed in a full screen without displaying the sub-LV area 330, the recording information area 340, and the operation area 350. On the screen 401 in the normal display mode (FIG. 4A), the header portion 310 (an operation area where a plurality of items for user operation are displayed), the LV area 320, and the sub-LV area 330 are longitudinally arranged. Meanwhile, in the full-screen display mode (FIG. 4C), a full-screen header portion 420 is displayed to be superimposed on a part of the LV area 320. The full-screen header portion 420 is an operation area where a part of the plurality of items for user operation is displayed. For example, the control unit 201 displays a reduced-display switching button 421 and an assistance setting button 422 in the full-screen header portion 420 to be superimposed on the main image displayed in the LV area 320. When the user touches the reduced-display switching button 421, the control unit 201 returns the display screen to the screen displayed immediately before the screen 403 in the full-screen display mode (for example, the screen 401 of FIG. 4A or the screen 402 of FIG. 4B). Similarly to the assistance setting button 315, the assistance setting button 422 is a setting button for selecting an assistance function such as enlarged display, marker display, or false-color display. As a display mode equivalent to the full-screen display mode, a display mode where the LV area 320 is displayed to be larger than the LV area 320 of FIG. 4A but is not displayed in a full screen may be settable.

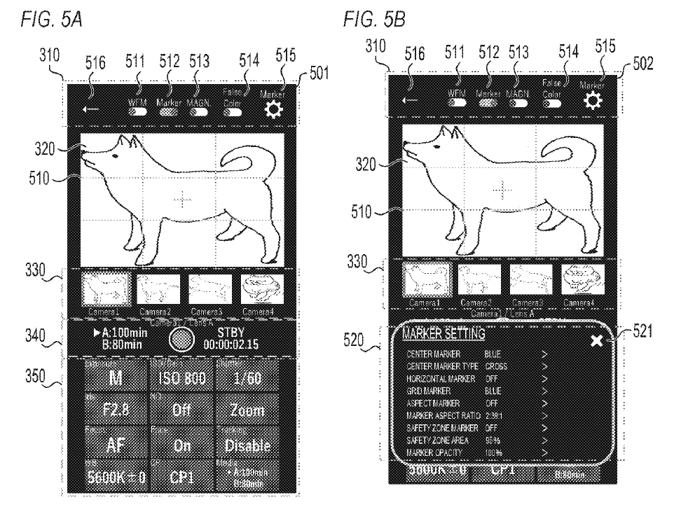

FIGS. 5A and 5B are schematic diagrams illustrating screen examples of the camera control application, and illustrate an example where the marker display is enabled. The camera control application has a marker function of displaying a marker to be superimposed on the LV image. The marker function is an assistance function of displaying a marker that is a guide line for confirming the composition. Due to the marker function, various markers such as a center marker indicating the center of an image, a horizontal marker indicating a horizontal direction of an image, and a grid marker that divides an image into a plurality of areas aligned in a horizontal direction and a vertical direction, can be displayed.

FIG. 5A illustrates an example of a screen where the marker display is executed in the normal display mode. The screen 501 of FIG. 5A is the same as the main screen 300 of FIG. 3, but FIGS. 5A and 3 are different in the display state (display content) of the header portion 310. For example, when the user touches the assistance setting button 315 while the main screen 300 of FIG. 3 is being displayed, the control unit 201 switches the display state of the header portion 310 from the state of FIG. 3 to the state of FIG. 5A. In FIG. 5A, a WFM switch 511, a marker switch 512, an MAGN switch 513, a False Color switch 514, a marker setting button 515, and a return button 516 are displayed in the header portion 310.

When the user touches the WFM switch 511, the control unit 201 performs switching to enable/disable display of a waveform monitor image representing a luminance distribution of the LV image (main image) acquired from the camera to be operated. When the user touches the marker switch 512, the control unit 201 performs switching to enable/disable the marker display. When the user touches the MAGN switch 513, the control unit 201 performs switching to enable/disable the enlarged display of the LV image. When the user touches the False Color switch 514, the control unit 201 performs switching to enable/disable the false color display of executing coloration on the LV image (converting each pixel value of the LV image into a pixel value corresponding to the luminance). When the user touches the marker setting button 515, the control unit 201 displays a marker setting screen. When the user touches the return button 516, the control unit 201 switches the display state of the header portion 310 from the state of FIG. 5A to the state of FIG. 3.

In FIG. 5A, the WFM switch 511, the MAGN switch 513, and the False Color switch 514 are in a disabled state, and the marker switch 512 is in an enabled state. An enabled state of a switch is a state where the function corresponding to the switch is enabled, and a disabled state of a switch is a state where the function corresponding to the switch is disabled. Therefore, the control unit 201 displays a marker 510 to be superimposed on the main image displayed in the LV area 320. Each of the LV images displayed in the sub-LV area 330 is small so that it is difficult for the marker to be a reference, and thus, the control unit 201 does not display a marker in the sub-LV area 330.

FIG. 5B illustrates an example of a marker setting screen. For example, when the user touches the marker setting button 515 while the screen 501 of FIG. 5A is being displayed, the control unit 201 transitions the display screen from the screen 501 of FIG. 5A to the screen 502 of FIG. 5B. On the screen 502 of FIG. 5B, a marker setting menu 520 is displayed to be superimposed on the screen 501 of FIG. 5A. The user can display a preferred marker by operating the marker setting menu 520. In FIG. 5B, the center marker and the grid marker are set to be enabled, and in FIGS. 5A and 5B, the center marker and the grid marker are displayed in the LV area 320. When the user touches the close button 521 of the marker setting menu 520 or an area outside the marker setting menu 520, the control unit 201 hides the marker setting menu 520 (marker setting screen).

In the first embodiment, it is assumed that individual marker setting values are recorded in the nonvolatile memory 203 for each of a plurality of LV images (a plurality of cameras), and when a main image (a camera to be operated) is switched, the displayed marker is also switched. Note that a marker setting value common to all LV images (all cameras) may be recorded in the nonvolatile memory 203, and the same marker may be continuously displayed even when the main image (camera to be operated) is switched.

Moreover, in the first embodiment, in the 2×2 display mode where the LV area 320 is not displayed, each of the LV images is relatively large, and thus, it is assumed that a marker is displayed in each of the LV images. Also in the full-screen display mode, it is assumed that a marker is displayed in the LV image (main image) acquired from the camera to be operated.

### Operation of Smartphone

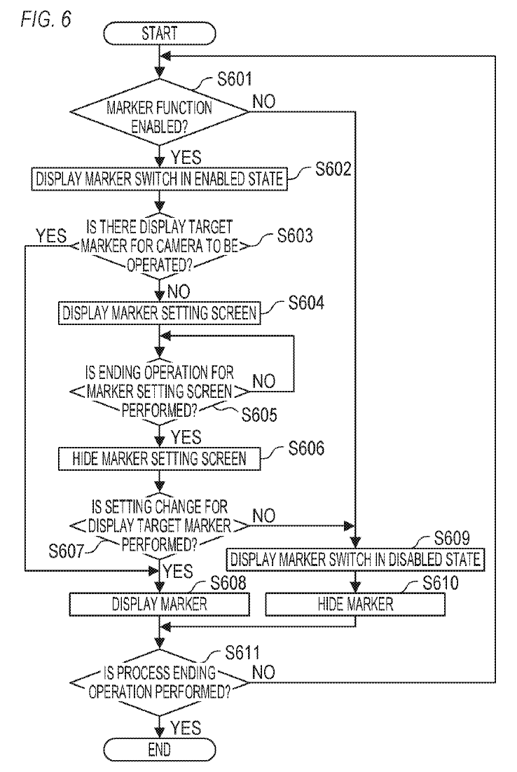

FIG. 6 is a flowchart illustrating an operation of the smartphone 200. The operation of FIG. 6 is implemented by the control unit 201 loading the program recorded in the nonvolatile memory 203 (for example, the program of the camera control application) on the working memory 204 and executing the program. For example, when the start of the camera control application is instructed, the operation of FIG. 6 starts.

At the start of the operation of FIG. 6, the control unit 201 loads information of the marker function (information representing the enabled/disabled (ON/OFF) state of the marker function) stored in the nonvolatile memory 203, in the working memory 204. In S601, the control unit 201 reads information representing the enabled/disabled state of the marker function (marker display) from the working memory 204, and determines whether or not the marker function is enabled. When the marker function is enabled, the process proceeds to S602, and otherwise, the process proceeds to S609. In response to a user operation such as a touch on the marker switch 512, the control unit 201 performs switching to enable/disable the marker function. The determination in S601 may be interpreted as a determination as to whether or not the state of the marker function has been switched from a disabled state to an enabled state.

In S602, the control unit 201 displays the marker switch 512 on the display unit 206 in an enabled state. The process of S602 may be interpreted as a process of switching the display state of the marker switch 512 from the disabled state to the enabled state.

At the start of the operation of FIG. 6, the control unit 201 loads the marker setting value stored in the nonvolatile memory 203 in the working memory 204. In S603, the control unit 201 reads the marker setting value from the working memory 204, and determines whether or not the display target marker is set for the camera to be operated. When the display target marker is set, the process proceeds to S608, and otherwise, the process proceeds to S604.

In S604, the control unit 201 displays a marker setting screen (marker setting menu 520 in FIG. 5B) of the camera to be operated, on the display unit 206. As a result, the user can easily grasp the reason why a marker is not displayed even though the marker switch 512 is in the enabled state. Here, the control unit 201 may perform control so as to highlight the marker setting button 515 that is an item for user operation to display the marker setting screen. By highlighting the marker setting button 515, the user can more easily grasp that the screen displayed in S604 is the marker setting screen.

In S605, the control unit 201 determines whether or not a user operation for hiding the marker setting screen displayed in S604 (operation to end the marker setting screen) has been performed. The process waits for the operation to end the marker setting screen, and when the operation to end the marker setting screen is performed, the process proceeds to S606. The operation to end the marker setting screen is, for example, a touch to the close button 521 in FIG. 5B or a touch outside the region of the marker setting menu 520.

In S606, the control unit 201 hides the marker setting screen displayed in S604.

In S607, after displaying the marker setting screen in S604, the control unit 201 determines whether or not the setting of the display target marker has been changed. When the setting of the display target marker has been changed, the process proceeds to S608. Otherwise (when operation to end the marker setting screen is performed while the display target marker is not set for the camera to be operated), the process proceeds to S609.

In S608, the control unit 201 displays the marker set as the display target to be superimposed on the LV image. In the case of the normal display mode, a marker is superimposed on the LV image (main image) displayed in the LV area 320 of FIG. 4A. In the case of the 2×2 display mode, a marker is superimposed on each LV image displayed in the sub LV area 330 of FIG. 4B. In the case of the full-screen display mode, a marker is superimposed on the LV image (main image) displayed in the LV area 320. When a user operation to add a display target marker is performed on the marker setting screen, the control unit 201 may immediately display the marker before hiding the marker setting screen. After the marker is displayed, when the camera to be operated is changed to another camera to which a display target marker is not set, the control unit 201 may display a marker setting screen of the other camera on the display unit 206. As a result, the user can easily grasp the reason why the marker is no longer displayed by the switching of the camera to be operated.

In S609, the control unit 201 displays the marker switch 512 on the display unit 206 in a disabled state. The process of S609 may be interpreted as a process of switching the display state of the marker switch 512 from the enabled state to the disabled state. When the state of the marker function is switched from enabled to disabled, the control unit 201 does not display the marker setting screen regardless of whether or not the display target marker is set for the camera to be operated. In addition, when the operation to end the marker setting screen is performed while the display target marker is not set for the camera to be operated, the control unit 201 hides the marker setting screen and switches the state of the marker function from enabled to disabled.

In S610, the control unit 201 hides the marker superimposed on the LV image.

In S611, the control unit 201 determines whether or not a user operation to end the operation of FIG. 6 (process ending operation) has been performed. When the process ending operation has been performed, the operation of FIG. 6 is ended, and otherwise, the process proceeds to S601. The process ending operation is, for example, a user operation to end the camera control application.

Note that the above operation may or may not be performed regardless of the display mode. For example, the above operation may be performed in the normal display mode, and another operation may be performed in the 2×2 display mode. A case where the state of the marker function is switched from disabled to enabled will be considered. In this case, in the 2×2 display mode, when the display target marker is set for a camera that is not the operation target, the marker is displayed to be superimposed on the LV image acquired from the camera that is not the operation target. Therefore, the marker setting screen may be displayed if the display target marker is not set for any of the cameras connected to the smartphone 200, and the marker setting screen may not be displayed if the display target markers are set for at least some of the cameras. The marker setting screen displayed in this case may or may not be the marker setting screen of the camera to be operated. If the display target markers are set for all the cameras connected to the smartphone 200, the marker setting screen may not be displayed, and if the display target markers are not set for at least some of the cameras, the marker setting screen may be displayed. The marker setting screen displayed in this case is a marker setting screen of the camera for which the display target marker is not set. The operation may be performed as described above in the normal display mode.

As described above, according to the first embodiment, when the state of the marker function is switched from disabled to enabled, if the display target marker is not set, the marker setting screen is displayed. As a result, the user can easily grasp the reason why a marker is not displayed even though the marker function is enabled.

Note that although the example in which one or more types of markers are superimposed on the LV image has been described, the image is not limited to the LV image, and may be a recorded captured image, an illustration being created, or the like. In addition, information different from the marker (other types of information configured by the selected element) may be superimposed on the image. For example, a selected imaging parameter among a plurality of imaging parameters (exposure value, ISO sensitivity, and the like) may be superimposed on the image. The information superimposed on the image may or may not be auxiliary information that assists the user's work. The present disclosure is applicable to various configurations in which display of information is switched between ON and OFF in response to a user operation, and one or more elements configuring the information are set to ON or OFF in response to another user operation. In addition, although the example of displaying the setting screen has been described, another notification screen indicating that all the elements are set to OFF may be displayed.

### Second Embodiment

Hereinafter, a second embodiment of the present disclosure will be described. The description of the same portions as those of the first embodiment will not be repeated.

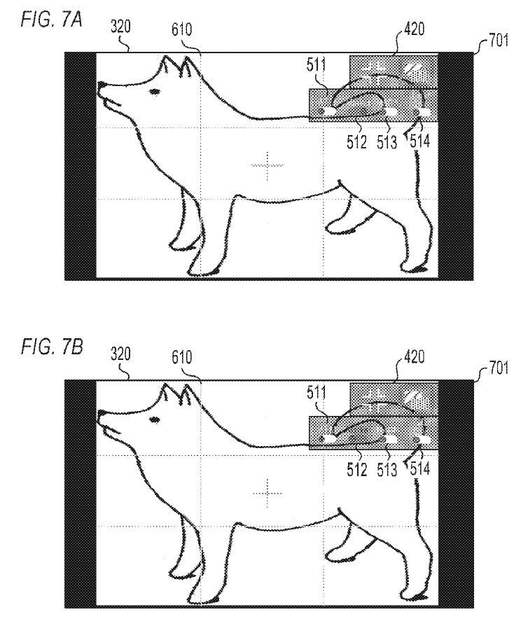

FIG. 7A illustrates an example of a screen where the marker display is executed in the full-screen display mode. A screen 701 of FIG. 7A is the same as the screen 403 of FIG. 4C, but the WFM switch 511, the marker switch 512, the MAGN switch 513, and the False Color switch 514 are displayed on the screen 701 of FIG. 7A. In FIG. 7A, the WFM switch 511, the MAGN switch 513, and the False Color switch 514 are in the disabled state, and the marker switch 512 is in the enabled state. In FIG. 7A, as in FIG. 5A, the control unit 201 displays the marker 510 to be superimposed on the main image displayed in the LV area 320.

FIG. 7B illustrates an example of a screen in a case where a user operation (such as a touch on the marker switch 512) to perform switching to enable/disable the marker display (marker function) is not accepted in the full-screen display mode. The screen 702 of FIG. 7B is a screen similar to the screen 701 of FIG. 7A, but the marker switch 512 is displayed in gray-out and the marker 510 is not displayed.

In the second embodiment, when the marker function is disabled, the display target marker is not set for any of the cameras connected to the smartphone 200, and the marker setting screen cannot be displayed, a user operation to perform switching to enable/disable the marker function is not accepted. The case where the marker setting screen cannot be displayed is a case where the full-screen display mode is set (a case where the full-screen display of the LV image is performed). In the full-screen display mode, the main image (camera to be operated) is switched according to the sliding operation on the main image (displayed LV image). Therefore, when the marker function is disabled and the display target marker is set for at least some of the cameras, even when the marker setting screen cannot be displayed, a user operation to perform switching to enable/disable the marker function is accepted.

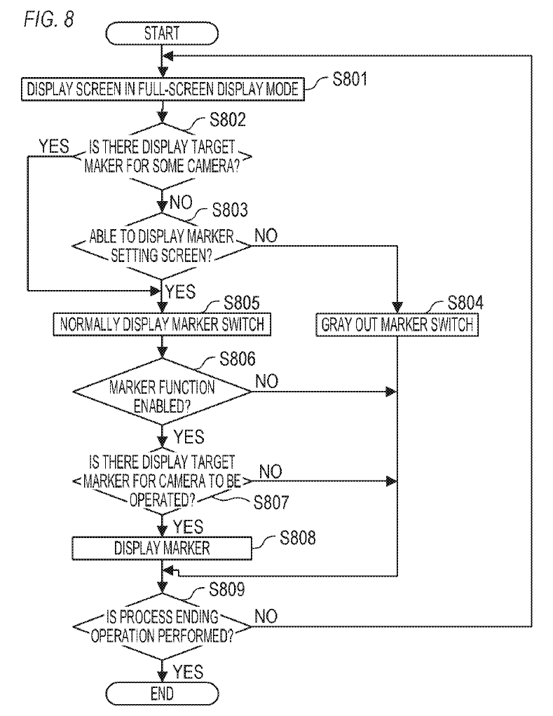

FIG. 8 is a flowchart illustrating an operation of the smartphone 200 in the full-screen display mode. The operation of FIG. 8 is implemented by the control unit 201 loading the program recorded in the nonvolatile memory 203 (for example, the program of the camera control application) on the working memory 204 and executing the program. For example, when the start of the full-screen display mode is instructed, the operation of FIG. 8 is started. It is assumed that the marker function is disabled at the start of the operation of FIG. 8. Although not illustrated in FIG. 8, it is assumed that the main image (camera to be operated) is switched according to the sliding operation.

In S801, the control unit 201 displays a screen in the full-screen display mode (for example, screen 403 of FIG. 4C) on the display unit 206.

In S802, the control unit 201 reads the marker setting value from the working memory 204, and determines whether or not the display target marker is set for at least some of the connected cameras. When the display target marker is set, the process proceeds to S805, and otherwise (when the display target marker is not set for any of the cameras), the process proceeds to S803.

In S803, the control unit 201 determines whether or not the marker setting screen can be displayed. When the marker setting screen can be displayed, the process proceeds to S805, and otherwise, the process proceeds to S804. In the second embodiment, when the marker setting screen cannot be displayed, the process always proceeds to S804 since the full-screen display mode is set.

In S804, as a state of accepting a user operation (such as a touch on the marker switch 512) to perform switching to enable/disable the marker function, the control unit 201 sets a state in which the user operation is not accepted. In the second embodiment, gray-out display of the marker switch 512 is enabled. Note that the marker switch 512 may remain in the normal display.

In S805, as a state of accepting a user operation (such as a touch on the marker switch 512) to perform switching to enable/disable the marker function, the control unit 201 sets a state of accepting the user operation. In the second embodiment, the normal display of the marker switch 512 is enabled.

In S806, as in S601 in FIG. 6, the control unit 201 determines whether or not the marker function is enabled. When the marker function is enabled, the process proceeds to S807, and otherwise, the process proceeds to S809. The determination in S806 may be interpreted as a determination as to whether or not the state of the marker function has been switched from a disabled state to an enabled state.

In S807, as in S603, the control unit 201 determines whether or not a display target marker is set for the camera to be operated. When the display target marker is set, the process proceeds to S808, and otherwise, the process proceeds to S809.

In S808, as in S608, the control unit 201 displays the marker set as the display target to be superimposed on the LV image.

In S809, as in S611, the control unit 201 determines whether or not a user operation (process ending operation) to end the operation of FIG. 8 has been performed. When the process ending operation has been performed, the operation of FIG. 8 ends, and otherwise, the process proceeds to S601. The process ending operation is, for example, a user operation to end the camera control application, a user operation to end the full-screen display mode, or the like.

As described above, according to the second embodiment, when the marker function is disabled, the display target marker is not set for any of the cameras, and the marker setting screen cannot be displayed, a user operation to switch the marker function to be enabled or disabled is not accepted. In this way, it is possible to suppress a state in which a marker is not displayed even though the marker function is enabled.

Note that the condition for not accepting the user operation to switch the marker function to be enabled or disabled is not limited to the above condition. For example, when the marker function is disabled, the display target marker is not set for the camera to be operated, and the marker setting screen cannot be displayed, the user operation to switch the marker function to be enabled or disabled may not be accepted.

A user operation to switch the marker function to be enabled or disabled may always be accepted. When the state of the marker function is switched from disabled to enabled, if the display target marker is not set and the full-screen display mode is set, the full-screen display mode may be canceled to display the marker setting screen.

The case where the marker setting screen cannot be displayed is not limited to the case where the full-screen display mode is set. For example, the case where the marker setting screen cannot be displayed may be another case where an area for displaying the marker setting screen cannot be secured. Since it is difficult to refer to a marker based on the entire LV image in confirmation of the enlarged LV image, when the enlarged display of the LV image is performed, the marker function may be forcibly disabled, and the marker setting screen may not be displayed.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, in the case of displaying information configured by a selected element, a user can easily grasp a reason why the information is not displayed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-051269, filed March 26, 2025, which is hereby incorporated by reference herein in its entirety.

What is claimed is:

1. An electronic device comprising:
a processor; and
a memory storing a program which, when executed by the processor, causes the electronic device to:
execute an acquisition process of acquiring an image;
execute a switching process of switching display of information between ON and OFF in response to a first user operation;
execute a setting process of setting one or more elements configuring the information to ON or OFF according to a second user operation different from the first user operation; and
execute a control process to, in a case where the display of the information is switched from OFF to ON by the switching process, if there is an element set to ON by the setting process, perform control to display the information including the element in a superimposed manner on the image, and if there is no element set to ON by the setting process, perform control to display a screen related to the setting by the setting process.

2. The electronic device according to claim 1, wherein
in the control process, in a case where the display of the information is switched from OFF to ON by the switching process, if there is no element set to ON by the setting process, control is performed to display a setting screen for setting by the setting process.

3. The electronic device according to claim 1, wherein
at a time of switching the display of the information from ON to OFF by the switching process, in the control process, control to display the screen is not performed regardless of whether or not there is an element set to ON by the setting process.

4. The electronic device according to claim 1, wherein
in a case where, after the display of the information is switched from OFF to ON by the switching process and the screen is displayed, a user operation to hide the screen is performed without an element set to ON,
in the control process, control is performed to hide the screen, and
in the switching process, the display of the information is switched from ON to OFF.

5. The electronic device according to claim 1, wherein
in a state in which the display of the information is OFF, in a case where there is no element set to ON by the setting process and the screen is unable to be displayed, in the control process, control is performed so as not to accept the first user operation.

6. The electronic device according to claim 5, wherein
a case where the screen is unable to be displayed is a case where full-screen display of the image is performed.

7. The electronic device according to claim 5, wherein
the control not to accept the first user operation is control to gray out an item for the first user operation.

8. The electronic device according to claim 1, wherein
in the acquisition process, a plurality of images are able to be acquired from a plurality of devices, respectively,
in the setting process, one or more elements are set to ON or OFF for each of the plurality of devices, and
in the control process, in a case where the display of the information is switched from OFF to ON by the switching process, if there is no element set to ON by the setting process for all the plurality of devices, control is performed to display the screen.

9. The electronic device according to claim 8, wherein
in a state in which the display of the information is OFF, in a case where there is no element set to ON by the setting process for all the plurality of devices, and the screen is unable to be displayed, in the control process, control is performed so as not to accept the first user operation, and
in a state in which the display of the information is OFF, in a case where there is an element set to ON by the setting process for at least one of the plurality of devices, even if the screen is unable to be displayed, in the control process, control not to accept the first user operation is not performed.

10. The electronic device according to claim 8, wherein
when the program is executed by the processor, the program further causes the electronic device to execute a selection process of selecting one of the plurality of devices, and
in the case where the display of the information is switched from OFF to ON by the switching process, if there is no element set to ON by the setting process for all the plurality of devices, in the control process, control is performed to display the screen of the device selected by the selection process.

11. The electronic device according to claim 10, wherein
in the control process, in a case where the display of the information is switched from OFF to ON by the switching process, if there is an element set to ON by the setting process for the device selected by the selection process, control is performed to display the information including the element in a superimposed manner on an image acquired from the selected device, and if there is no element set to ON by the setting process for the device selected by the selection process, control is performed to display the screen of the device selected by the selection process.

12. The electronic device according to claim 11, wherein
in a case where the display of the information is switched from OFF to ON by the switching process, if there is an element set to ON by the setting process for the device selected by the selection process, in the control process, control is performed to display the information including the element in a superimposed manner on the image of the device selected by the selection process, and
after the information is displayed, if the device selected by the selection process is changed to an other device having no element set to ON by the setting process, in the control process, control is performed to display the screen of the other device.

13. The electronic device according to claim 7, wherein
in a case where the display of the information is switched from OFF to ON by the switching process, if there is no element set to ON by the setting process for at least one of the plurality of devices, in the control process, control is performed to display the screen of the device for which there is no element set to ON by the setting process.

14. The electronic device according to claim 1, wherein
in a case where the display of the information is switched from OFF to ON by the switching process, if there is no element set to ON by the setting process and full-screen display of the image is performed, in the control process, control is performed to cancel the full-screen display and display the screen.

15. The electronic device according to claim 1, wherein
during display of the screen, in the control process, control is performed to highlight an item for a user operation to display the screen.

16. The electronic device according to claim 1, wherein
the image is a captured image,
the element is a guide line for composition confirmation, and
the information includes one or more types of guide lines.

17. The electronic device according to claim 1, wherein
in the control process, in a case where the display of the information is switched from OFF to ON by the switching process, if there is no element set to ON by the setting process, control is performed to display a notification screen indicating that all the elements are set to OFF.

18. A control method of an electronic device, comprising:
acquiring an image;
switching display of information between ON and OFF in response to a first user operation;
setting one or more elements configuring the information to ON or OFF according to a second user operation different from the first user operation;
performing, in a case where the display of the information is switched from OFF to ON, if there is an element set to ON, control to display the information including the element in a superimposed manner on the image; and
performing, in a case where the display of the information is switched from OFF to ON, if there is no element set to ON, control to display a screen related to the setting.

19. A non-transitory computer readable medium that stores a program, wherein the program causes a computer to execute a control method of an electronic device, the control method comprising:
acquiring an image;
switching display of information between ON and OFF in response to a first user operation;
setting one or more elements configuring the information to ON or OFF according to a second user operation different from the first user operation;
performing, in a case where the display of the information is switched from OFF to ON, if there is an element set to ON, control to display the information including the element in a superimposed manner on the image; and
performing, in a case where the display of the information is switched from OFF to ON, if there is no element set to ON, control to display a screen related to the setting.
